(19) United States
(12) Patent Application Publication
(10) Pub. No.: US 2006/0230159 A1
(43) Pub. Date: Oct. 12, 2006

(54) Method for supplying content to a user device in a communication system and apparatus therefor

(76) Inventors: Emma L. Jones, Bradford-on-Avon (GB); Richard Heywood, Cirencester (GB)

Correspondence Address: MOTOROLA, INC., 1303 EAST ALGONQUIN ROAD, IL01/3RD, SCHAUMBURG, IL, 60196, US

(21) Appl. No.: 10/569,110

(22) PCT Filed: Sep. 1, 2004
(86) PCT No.: PCT/EP04/51982

§ 371 Date: Feb. 21, 2006

(30) Foreign Application Priority Data
Oct. 24, 2003 (GB) 0324802.8

(51) Int. Cl. G06F 15/16

(52) U.S. Cl. 709/228

(57) ABSTRACT

The invention relates to an apparatus and method for supplying content to user devices in a communication system. In a described embodiment a content proxy is provided, which receives content from a broadcast distribution network, acting as a broadcast overlay network, and provides the content to a base station. Thus content can be broadcast to the user device by the base station without requiring backhaul communication system resources to be allocated to the user. The communication with the user device may utilize shared channels. The content proxy and/or the base station may be provided with memory that enables playback of content on demand. Additionally or alternatively, the content proxy and/or the base station may be provided with memory for storing content originating at the user device prior to forward transmission through the communication system at a lower data rate than the data rate at which it was received from the user device and/or being multiplexed with other user data.

The invention relates to an apparatus and method for supplying content to user devices in a communication system. The invention also relates to an apparatus and method for transferring content from a user device in a communication system.

Historically, communication systems have been developed to provide voice communication. Since the transmission of intelligible voice communication requires relatively little bandwidth, early communication systems were designed to provide each user with only a relatively small bandwidth. An example of such a wireless communication system is the Global System for Mobile communication (GSM system), and an example of such a fixed line communication system is the standard telephone system based on copper wire used in many countries.

Currently communication systems that are capable of allocating more bandwidth to each user are available and it is envisaged that such communication systems will become increasingly available in the future. Examples of such wireless communication systems are 2.5 generation networks such as the General Packet Radio Service (GPRS) system and the Enhanced Data for Global Evolution (EDGE) system based on the GSM system as well as third generation networks such as the Universal System for Mobile Communications (UMTS) system under standardization by the European Telecommunications Standards Institute (ETSI). Examples of such fixed line communications systems are DSL, ADSL, ISDN and cable communication systems.

The higher bandwidth that may be allocated to each user in such systems enables the operator of the communication system to provide additional services to the subscribers. An example of such an additional service is the provision of content, such as music and/or video content to subscribers' user devices and/or the transmission of content originating at the user device through the communication system.

A key selling point of third generation wireless communication systems is the ability to provide broadcast or multicast content to mobile users. It is desirable for communication system operators efficiently to manage the provision of bandwidth within the network and on the air interface to support the broadcast/ multicast of content to users, so as to maximize the revenue generated by the communication system.

A particular problem arises when considering the provision of content on demand and/or personal playback of content, for example the playing of multimedia clips and/or video on demand. Since a multicast or broadcast technique can no longer be used for such services without imposing significant storage requirements upon the user devices, an individual user channel is used carrying the specific content for that user. This approach is wasteful of communication system capacity.

In many communication systems, in addition to the user device receiving content from the communication system, for example by way of broadcast or multicast, or using a specific user channel, it is desirable to enable the user device to transfer content data such as photographs or multimedia clips to another user or a server in the core network of the communication system or to an external network, for example, in a bandwidth-efficient manner.

It is desirable to allow communication system operators flexibility in billing arrangements in providing services to users. In particular, with respect to broad cast or multicast services a problem may arise since the channel is shared and thus the content cannot be charged for in terms of bandwidth utilized by the user, as would be conventional. Although services may be provided on a pay-per-service or pre-paid basis, these arrangements require an existing contract or payment agreement and do not facilitate on-demand payment for the broadcast service.

Different embodiments of the invention are intended at least partially to address one or more of the problems outlined above.

In accordance with one aspect of the invention, there is provided a method for supplying content to a user device in a communication system as claimed in claim 1.

In accordance with a second aspect of the invention there is provided an apparatus operating in a communication system as claimed in claim 12.

In accordance with a third aspect of the invention, there is provided a method for transferring content from a user device in a communication system, as claimed in claim 27.

In accordance with a second aspect of the invention there is provided an apparatus for transferring content from a user device in a communication system, as claimed in claim 29.

In a described embodiment a content proxy is provided, which receives content from a broadcast distribution network, acting as a broadcast overlay network, and provides the content to a base station. Thus content can be broadcast to the user device by the base station without requiring backhaul communication system resources to be allocated to the user. The communication with the user device may utilize shared channels. The content proxy and/or the base station may be provided with memory that enables playback of content on demand. Additionally or alternatively, the content proxy and/or the base station may be provided with memory for storing content originating at the user device prior to forward transmission through the communication system at a lower data rate than the data rate at which it was received from the user device and/or being multiplexed with other user data.

For a better understanding of the present invention, and to show how it may be brought into effect, reference will now be made by way of example to the accompanying drawings in which:

FIG. 1 shows an outline of an arrangement in a wireless communication system in which a first embodiment is implemented;

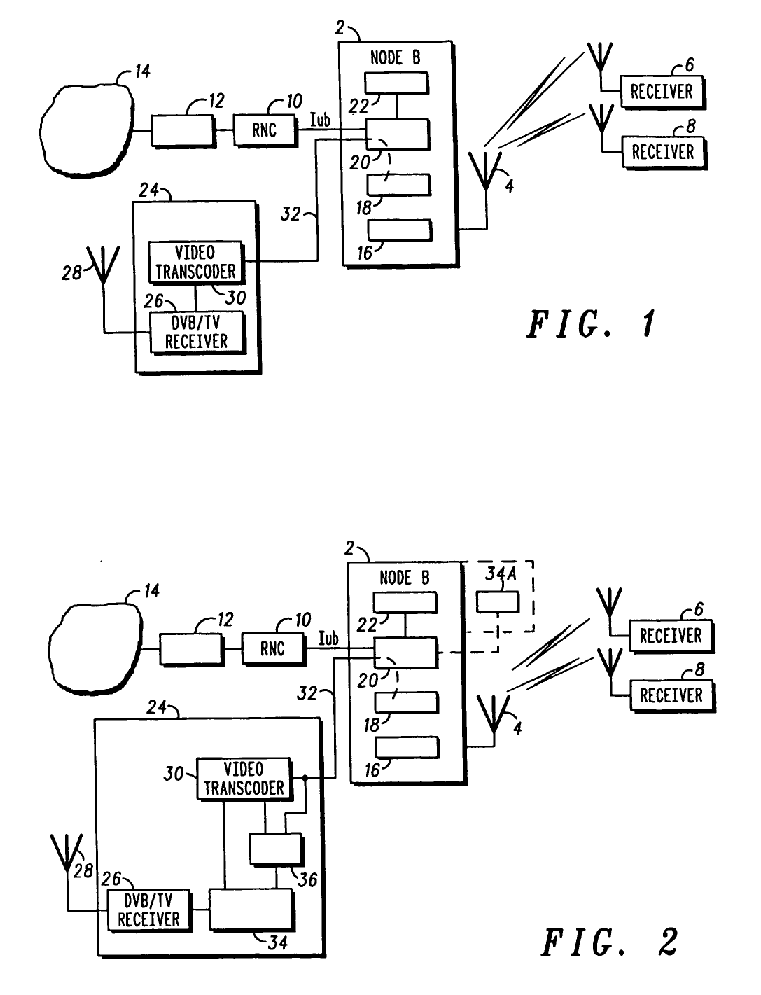

FIG. 2 shows an outline of an arrangement in a wireless communication system in which a second embodiment is implemented;

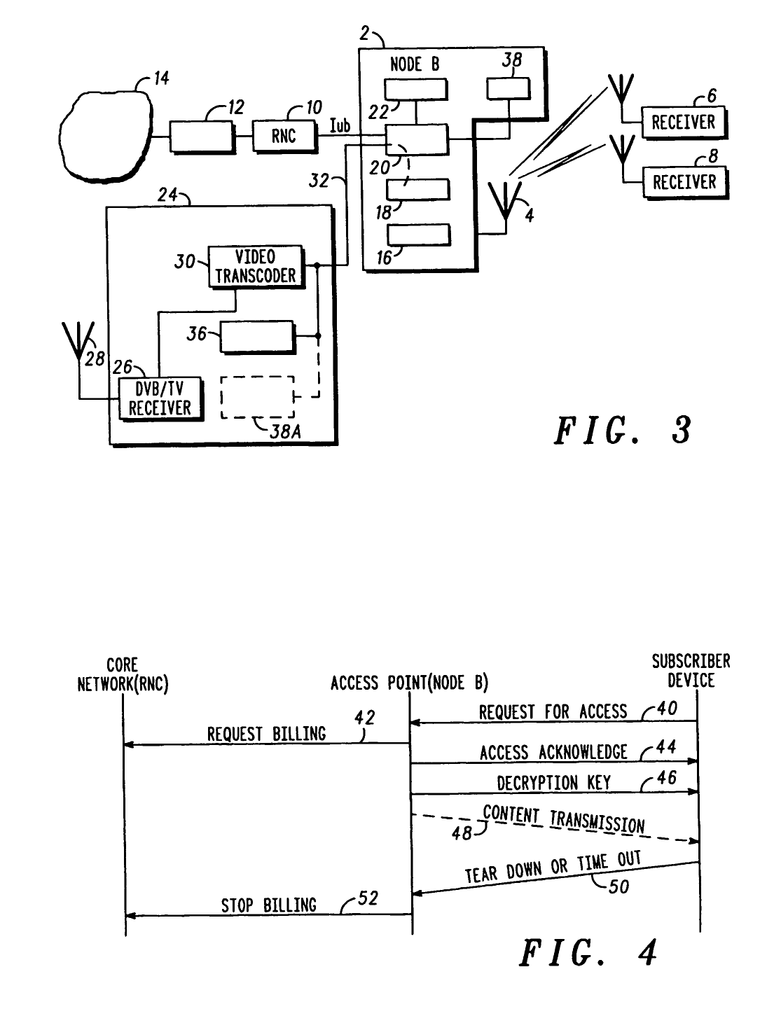

FIG. 3 shows an outline of an arrangement in a wireless communication system in which a third embodiment is implemented;

FIG. 4 shows signaling to enable a user device to access content in an embodiment.

Embodiments will now be described with reference to a third generation UMTS wireless communication system. However, it should be noted that embodiments may be applied to other communication systems, and so the skilled person will understand that the system specific arrangements are not essential to the invention. Additionally, it should be noted that embodiments may be applied to either a fixed line or to a wireless communication system.

FIG. 1 shows an outline of an arrangement in a wireless communication system in which an embodiment is implemented. Details of the wireless communication system that are not relevant have been omitted for clarity, as such details will be familiar to a skilled person.

Communication system infrastructure supporting a cell of a cellular wireless communication system is shown in FIG. 1. A base station 2 (called a node B in UMTS terminology) of the cell provides communication services via an antenna 4 to user devices within the cell, including user devices 6, 8 as shown (further user devices are not shown for clarity). The node B 2 is coupled to a base station controller 10 (called a radio network controller (RNC) in UMTS terminology). In turn, the RNC 10 is coupled to a switch 12 (called a serving gateway support node (SGSN) in UMTS terminology). In turn, the SGSN 12 is coupled to an external network 14, such as the Internet or other network, to route communications relating to a user device supported by the SGSN 12 outside the communication system and/or is coupled to other SGSNs in the communication system (not shown) to route communications relating to a user device supported by the SGSN 12 within the communication system. For completeness, it should be noted that typically each SGSN would be coupled to a number of RNCs, and each RNC would be coupled to a number of node Bs.

The node B 2 is typically provided with a transceiver 16, modem 18, switch 20 and a controller 22. In practice, the node B 2 will have a plurality of such modules, and may include additional modules. Such additional modules are not relevant to an understanding of the invention and have therefore been omitted for clarity.

The switch 20 is coupled to the interface with the RNC 10 and acts to switch different channels received from or transmitted to the RNC 10 and transmitted to or received from the user devices 6, 8 within the cell. These different channels are typically multiplexed onto the interface with the RNC 10. This interface is the lub interface in UMTS terminology. The modem 18 and transceiver 16 are coupled between switch 20 and antenna 4. The modem 18 modulates the channel information received from the RNC 10 via the switch 20 for onward transmission over the air interface to the user devices and demodulates channel information received from the user devices over the air interface for onward transmission to the RNC 10 via the switch 20. The transceiver 16 transmits the modulated channel information from modem 18 to the user devices over the air interface and passes received modulated channel information from the plurality of user devices over the air interface to the modem 18 for demodulation. The controller 22 controls the operation of the node B.

The node B 2 is thus able to maintain a plurality of signaling and traffic channels with a plurality of user devices in the node B's cell.

In the embodiment described with reference to FIG. 1, a content proxy 24 is provided as a content source. Although generally, as shown, it is envisaged that the content proxy 24 will be a separate device, the described functionality may be combined with the Node B functionality, resulting in an enhanced Node B, or may be combined physically with another suitable device within the discretion of the skilled person.

Content proxy 24 provides a local content source for the node B 2 by making use of content distribution networks and treating the content distribution network as an overlay network. Thus, the provision of a local content source for the node B allows the node B to offer content to user devices without requiring the allocation of bandwidth on a user channel on the lub communication system interface between the RNC and the Node B and the other interfaces between communication devices in the communication system. The elimination of the requirement to provide bandwidth to support content provision to the users may result in a reduction in the cost of providing the communication system infrastructure and/or an increase in the number of users that can be supported by a given dimensioning of the infrastructure or communication system interfaces. Since the content is being provided by the node B via the air interface, no special adaptation of the user devices to receive the content is necessary.

The content distribution network may be selected in accordance with the discretion of a skilled person. Examples of standard content distribution networks are: satellite broadcast networks; cable networks; terrestrial broadcast networks, although any content distribution network, including a dedicated content distribution network, may be used. In addition, clearly it is possible in principle for the content proxy 24 to be able to obtain content from more than one content distribution network.

Thus the content proxy 24 is provided with a content receiver 26 for receiving content from the content distribution network. In the illustrated embodiment the content distribution network is a digital terrestrial broadcast network, and so the content receiver 26 is a digital terrestrial broadcast receiver 26 which is coupled to an antenna 28 for receiving the digital terrestrial broadcast signals. The content proxy 24 is also provided with a content transcoder 30, coupled to the content receiver 26, for transcoding the signals received from the content receiver 26 for onward transmission to the node B 2 via a content interface 32 between the switch 20 of node B 2 and the content proxy 24.

Typically, as will be apparent to a skilled person, the content will received from the content distribution network in a content format. The content format may for example be a standard content format, for example MPEG-4 format for video or MPEG-3 format for audio, for example. The transcoder 30 transcodes the signals for onward transmission to the node B via the content interface 32.

The content interface 32 may utilize any suitable transmission format, as will be apparent to a skilled person. In particular, an Ethernet connection may be used in some embodiments.

In the simplest embodiment, as illustrated, the content proxy 24 is not provided with a controller and content received by the content proxy 24 from the content distribution network is merely streamed to the Node B 2 over the content interface 32. However, in other embodiments, particularly applicable for example to situations where a selection from a plurality of channels or sources is to be made, the content proxy 24 may be provided with a controller, for controlling selection of the desired content and/or for controlling the transfer of the selected content to the node B across the content interface 32. This controller may be the same as the controller described later with reference to FIGS. 2 and 3, or may be a separate device.

The content received via content interface 32 may be treated by the node B 2 in the same manner as channels received on the lub interface. Thus effectively the content channel input via the content interface 32 may be coupled through the node B 2 via the switch 20, modem 18 and transceiver 16 to be transmitted to one or more user devices.

Generally it is envisaged that a core network entity, such as the RNC 10, would be responsible for the setting up of the content service to a user device. The RNC 10 would be aware that the Node B 2 is connected to a content proxy 24. This may be achieved, for example, via a network configuration option, or via signaling as will be apparent to a skilled person. In order to set up the content service, the RNC 10 would send control messages to the node B 2 to provision the air interface (for example by allocation of an air interface channel to the content service) and also to set up a channel or link to the content proxy 24 over the content interface 32. The node B may also inform the receiving user device(s) of the channel on which the content is to be broadcast. In addition it is envisaged that the RNC 10 may send control messages to a content proxy controller, if present, (not shown) to control selection of the content from the content distribution network and/or to control transfer of the selected content to the node B across the content interface 32. The node B controller 22 controls the operation of the switch 20 modem 18 and transceiver 16 to transmit the content received from the content proxy 24 over the content interface 32 on the air interface channel to the user device.

It should be noted that the content proxy 24 and node B 2 may provide local content provision dedicated to a single user or group of users. Alternatively, the content proxy 24 and node B 2 may provide effectively local re-broadcast of one or more channels received from the content distribution network, that can be offered on an intermittent basis (for example to broadcast films) or on a permanent or semi-permanent basis (for example to broadcast a continuous news channel such as the CNN™ news channel or the BBC™ News24 channel).

Thus the air interface channel may be a dedicated air interface channel, such as a normal air interface traffic channel, set up for a single user. However, especially when broadcasting to a number of users it will be more efficient to use a shared access channel as the air interface channel. Typically, a number of shared access channels might be provided by a single node B, each effectively broadcasting different content received from the content proxy 24 over the content interface 32. Clearly, the content interface 32 must be provided with sufficient bandwidth and sufficient channels etc to be able to provide the number of content channels provided by the node B 2.

An example of a shared access channel that can be used in this embodiment is a Forward Access Channel (FACH) used in the UMTS cellular communication system, although other shared channels provided in other communication systems could also be used as appropriate to provide a shared channel carrying content received from the content proxy 24 to the user devices.

A second embodiment is now described with reference to FIG. 2. The same reference numerals as FIG. 1 have been used in FIG. 2 for the same or similar components or functions.

In the embodiment shown in FIG. 2, the content proxy 24 is provided with content storage 34. The content storage 34 in FIG. 2 is coupled to the content receiver 26 to store the content from the content distribution network. The content storage 34 is also coupled to the content transcoder 30 for transcoding the content stored in the content storage 34 prior to transmission to the node B 2 over the content interface 32.

Again, as in the first embodiment, typically the content will received from the content distribution network in a content format. The content format may for example be a standard content format, for example MPEG-4 format for video or MPEG-3 format for audio, for example. The transcoder 30 transcodes the signals for onward transmission to the node B via the content interface 32.

The content interface 32 may utilize any suitable transmission format, as will be apparent to a skilled person. In particular, an Ethernet connection may be used in some embodiments.

The content proxy 24 is also provided with a content proxy controller 36 for controlling the operation of the content proxy 24. The content proxy controller 36 is coupled to the content transcoder 30 and to the content storage 34, and also communicates with the node B controller 22 and/or the RNC 10 in order to control access to the content stored in content storage 34.

This embodiment may provide an advantageous means to enable supply of the content received from the broadcast network to user devices within the cell supported by the node B on an individual basis i.e. not on a broadcast basis. Thus the user device may effectively have access to playback on demand by virtue of the local storage of the content distribution network content.

In order to achieve this, a channel is established between the user device, wishing access to the content on demand, and the content proxy 24, providing locally stored content, via the user device interface i.e. the air interface, the transceiver 16, modem 18 and switch 20 of the node B 2, and the content interface 32. Traffic on this channel is controlled by the node B controller 22 and the content proxy controller 36.

In more detail, it is envisaged in one embodiment that in response to a user request for the content, the RNC 10 will message the content proxy controller 36 to provide the content over the content interface 32. The RNC 10 would also send control messages to the node B 2 to provision the air interface (for example by allocation of an air interface channel to the content service) if necessary. The RNC 10/node B 2 will also inform the receiving user device(s) of the channel on which the content is to be broadcast. The node B controller 22 controls the operation of the switch 20 modem 18 and transceiver 16 to transmit the content received from the content proxy 24 over the content interface 32 on the air interface channel.

However, although the function of a base station controller such as the RNC 10 is generally to control the operation of a base station, such as the Node B 2, it is not strictly necessary for the RNC 10 to be involved in interacting with the content proxy controller, and a suitably modified node B could handle the content request locally. This is particularly so if the air interface channel for the content transfer is already provisioned.

Thus the provision of local content storage enables provision of playback on demand to a user device without requiring the allocation of bandwidth on the communication system interface. This can be especially advantageous in providing innovative services to users, for example enabling users to watch a film or listen to music at a time that suits the user instead of the broadcast time: in addition the embodiment may also enable playback of parts of for example video and/or audio content on user demand, for example to enable playback of sports clips and such like.

Content received from the communication system over the communication system interface lub, or content from another source, may be stored locally for future playback. Such transfer over the lub interface may be carried out at night time or other time when the lub utilization is low. This storage of incoming content on the lub in the content storage 34 of the content proxy 24 as described above may be carried out via switch 20 under control of the node B controller 22 and the content proxy controller 36.

Although in the arrangement illustrated in FIG. 2 the content storage 34 is included in the content proxy 24, this is not necessary and the content storage 34 in other embodiments may be provided in a content storage 34a as part of the node B 2 or in another device local to the node B (shown in dotted outline only).

In particular, it is noted that the use of a content storage 34a local to the node B 2 is possible even without the use of the content proxy 24, as described above. In this situation, content received from the communication system over the communication system interface lub, or content from another source, can be stored, for example via switch 20, in the content storage 34a in the node B 2 or in another device local to the node B until it is required. In this situation, it is envisaged that a local content controller (not shown) may be provided to control the storage and/or retrieval of the content in the content storage 34a in the node B or in another device local to the node B, or the storage and retrieval may be handled by the node B controller 22.

Once again, it is not strictly necessary for the RNC 10 to be involved in interacting with the content storage 34a, and a suitably modified node B could handle the request locally. This is particularly so if the air interface channel for the content transfer is already provisioned.

In addition, although in the arrangement shown in FIG. 2 the content storage 34 stores content prior to transcoding, in some embodiments the transcoded data may be stored in the content storage 34.

A third embodiment is shown in FIG. 3. Again, the same reference numerals as FIG. 1 have been used in FIG. 3 for the same or similar components or functions.

The node B is provided with reverse content storage 38. In the illustrated arrangement the reverse content storage 38 is provided as part of the node B 2 or in another device local to the node B. However, if a content proxy 24 is provided, the reverse content storage may be provided as a reverse content storage 38a (shown in dotted outline in FIG. 3) in the content proxy 24.

It should be noted that storage 34 and 34a and 38 and 38a may be provided by any sort of memory. In addition, content storage 34 and reverse content storage 38a may physically be accommodated in the same memory device, and content storage 34a and reverse content storage 38 may also physically be accommodated in the same memory device.

The reverse content storage 38 and/or 38a is provided to allow the node B 2 to store multimedia content or high data rate data being sent from the user device through the communication system. Instead of a channel being set up, and thus channel resources being allocated on all the necessary communication interfaces within the communication system, for the transfer of the data from the user device through the communication system, initially a channel is set up only between the user device and the reverse content storage 38 or 38a via the antenna 4, the transceiver 16, modem 18 and switch 20, under the control of the node B controller 22 and/or the RNC 10.

Subsequently, the node B controller 22 is able to transfer the multimedia content or other data from the reverse content storage 38 or 38a on to its final destination via the communication system at a lower data rate than the original transmission from the user device. One way this can be achieved is by multiplexing the data on a communication interface channel, for example on the lub interface.

Thus high data rate data, such as streaming audio or video, can be transferred via the communication interface at a lower data rate than required to support the streaming audio and video. Thus the total bandwidth requirements of the communication system, and in particular the communication interface lub, may be minimized, whilst avoiding the need for the user device to be provided with a large memory.

FIG. 4 shows signaling between a user device 6, 8, the node B 2 and the core network, for example RNC 10, to enable the user device 6, 8 to access content from the Node B 2, in an embodiment. This embodiment is described in the context of a system as described above with reference to FIG. 1, 2 or 3, in which the user device accesses broadcast content.

This embodiment is described with reference to signaling proposed for the UMTS system currently under standardization. However, the skilled person may use any appropriate signaling protocols.

Initially the user becomes aware of the broadcast service available from the serving node B 2. This might be achieved in a variety of ways, for example by means of a Short-Message Service Cell broadcast (SMS-CB); an MBMS broadcast advertisement; a push mechanism such as WAP or SMS-PP, or via a pull mechanism such as an internet address.

When the user wishes to access the broadcast, the user device 6 sends a Request for Access message 40 to an access point, which in this embodiment is the serving Node B 2. In some embodiments the Request for Access message will include information relating to or identifying the service that the user wishes to access.

The Request for Access message may be on any suitable channel, and for example may be made on a shared uplink channel, for example a shared access channel. The choice of access channel is within the discretion of the skilled person in view of the communication system being used. An example of a shared access channel is the Random Access Channel (RACH) used in UMTS, which will be used in the exemplary described embodiment.

In the illustrated embodiment, the Node B 2 sends a Request Billing message 42 to the core network eg a billing system via the RNC 10 over the communication interface lub. In addition, the Node B 2 acknowledges the Request for Access message with an Access Acknowledge message 44. It is envisaged that the billing may include the ability to bill based on one or more factor, such as: amount of data transferred/time in use; service type; service area; time of day etc.

The Access Acknowledge message 44 may be on any suitable channel, and for example may be made on a shared downlink channel. The choice of downlink channel is within the discretion of the skilled person in view of the communication system being used. An example of a shared downlink channel is the Forward Access Channel (FACH) used in UMTS, which will be used in the exemplary described embodiment. In this connection it is noted that it is envisaged that the FACH can carry up to 384 kbps, which is sufficient for the transmission of most types of content.

The Access Acknowledge message may also include information relating to the downlink channel e.g. the FACH channel in the exemplary embodiment, on which the requested content is broadcast.

In addition, it should be noted that in the illustrated embodiment both uplink and downlink channels are shared channels. Clearly, in many situations this arrangement provides the greatest efficiencies for the communication system operator since a large number of users may be accommodated while utilizing only a finite bandwidth. However, dedicated traffic channels may also be used in appropriate situations.

In many situations the content will be encrypted by the communication system prior to transmission on the downlink channel, to ensure security and payment for the content. The node B 2 may also send the user device 6 a decryption key in a Decryption Key message 46 to allow the user device to access the requested broadcast.

The user device may then access the requested content as the Content Transmission 48 on the downlink channel, i.e. the FACH channel in the exemplary embodiment. In the exemplary embodiment, the requested content is a film, so the video data is transmitted as the Content Transmission 48 on the allocated FACH.

In the exemplary embodiment at the end of the Content Transmission 48 the user device sends a Teardown message 50 to the node B 2. In response, the node B 2 sends a Stop Billing message 52 to the core network eg a billing system via the RNC 10 over the communication interface lub

It is envisaged that in some embodiments the initial access request may act as a request for authorization for a fixed time period, such that the periodic issuing of the RACH/FACH messages can provide billing and access/authentication, quantised by the time period.

It is also envisaged that in some embodiments only an internal to the node B billing message is generated or note is made in response to the Request for Access message 40. When the service is no longer required, the billing message can be transferred to the infrastructure/billing system.

Thus a method and apparatus for supplying content to a user device in a communication system has been described. In addition a method and apparatus for transferring content from a user device in a communication system has been described.

1. A method for supplying content to a user device in a communication system that includes a base station and base station controller, comprising the steps of:
providing a content source coupled to the base station through a content interface;
receiving content from a network by the content source;
transcoding the content for use by the user device;
providing the content to the base station from the content source via the content interface, and
supplying the content by the base station to the user device via a communication system air interface in response to an access request on an access channel.

2. The method as claimed in claim 1, wherein the network is an external network separate from the communication system.

3. The method as claimed in claim a 1 wherein the air interface uses a shared broadcast channel being a Forward Access Channel (FACH) in a 3GPP compliant system.

4. The method as claimed in claim 1 wherein the receiving step includes the network being coupled to the communication system through the base station controller and the providing step includes providing storage for the content.

5. The method as claimed in claim 1 wherein the access channel is a Random Access Channel (RACH) in a 3GPP compliant system.

6. The method as claimed in claim 1 wherein a billing message is generated in response to receipt of an access request.

7. The method as claimed in claim 1, further comprising the steps of
storing content received from a user device over the communication system air interface, and
forwarding the stored content on the communication system to the network via a system interface.

8. The method as claimed in claim 7 wherein the stored content is forwarded at a lower data rate over the system interface than the data rate over the air interface and is multiplexed with other user data on the system interface.

9. The method as claimed in claim 4 further comprising the step of:
storing content received from a content distribution network.

10. The method as claimed in claim 1 where the content source is remotely supplied using a communication system interface.

11. The method as claimed in claim 4 further comprising the step of:
storing content received from a network coupled to the communication system through the base station controller over the communication system interface.

12. The method as claimed in claim 9 further comprising the steps of:
becoming aware of content available from the content source; and
setting up of the content service to a user device, including the substeps of:
sending a control message to provision the air interface;
set up the content interface to the content source, and
informing the user device of the channel on which the content is to be supplied.

13. The method as claimed in claim 11 wherein the stored content is forwarded at a lower data rate over the system interface than the data rate over the air interface and is multiplexed with other user data on the system interface.

14. An apparatus operating in a communication system that includes a user device, base station, and base station controller, the apparatus comprising.
a content source;
a content interface for coupled content from a content source to the base station;
a network for providing content to the content source;
a transcoder for transcoding the content for use by the user device; and
an air interface for supplying by the base station the user device with content received via the content interface in response to an access request from the user device on an access channel thereof.

15. The apparatus as claimed in claim 14, wherein the network is an external network separate from the communication system.

16. The apparatus as claimed in claim 14 wherein the air interface uses a shared broadcast channel being a Forward Access Channel (FACH) in a 3GPP compliant system.

17. The apparatus as claimed in claim 14 wherein the network is coupled to the communication system through the base station controller and means for providing storage for the content.

18. The apparatus as claimed in claim 14 wherein the access channel is a Random Access Channel (RACH) in a 3GPP compliant system.

19. The apparatus as claimed in claim 14 comprising means for generating a billing message in response to receipt of an access request.

20. The apparatus as claimed in claim 17 wherein the content received from the user device over the communication system air interface and is stored in the content source, and the stored content is forwarded on the communication system to the network via a system interface.

21. The apparatus as claimed in claim 20 wherein the stored content is forwarded at a lower data rate over the system interface than the data rate over the air interface and is multiplexed with other user data on the system interface.

22. The apparatus as claimed in claim 17 further comprising means for storing content received from a content distribution network.

23. The apparatus as claimed in claim 20 where the content source is remotely supplied using a communication system interface.

24. The apparatus as claimed in claim 17 further comprising a communication system interface; means for storing content received from the network coupled to the communication system through the base station controller over the communication system interface.

25. The apparatus as claimed in claim 22 wherein the user device becomes aware of content available from the content source: and the base station controller sets up the content service to a user device by: sending a control message to provision the air interface, setting up the content interface to the content source, and informing the user device of the channel on which the content is to be supplied.

26. The apparatus as claimed in claim 20 further comprising local user data storage means and transport control elements, wherein content sent by users over the user interface is stored at the local user data storage means and then forwarded via the system interface under control of transport control elements.

27. The apparatus as claimed in claim 25 wherein the stored content is forwarded at a lower data rate over the system interface than the data rate over the air interface and is multiplexed with other user data on the system interface.

28-32. (canceled)

33. An apparatus as claimed in claim 14, further comprising:
a user interface for communicating with the user device;
a system interface for communicating with at least one other communication apparatus of the communication system;
local user data storage means; and
transport control elements;
wherein content sent by users over the user interface is stored at the local user data storage means and then forwarded via the system interface under control of transport control elements.

34. The apparatus as claimed in claim 33 wherein the stored content is forwarded at a lower data rate over the system interface than the data rate over the user interface and is multiplexed with other user data on the system interface.
